(19) United States
(12) Patent Application Publication
(10) Pub. No.: US 2006/0185567 A1
(43) Pub. Date: Aug. 24, 2006

(54) Ground injection apparatus

(76) Inventors: Jonathan William Hargreaves, Cheshire (GB); Brian Hartley, Cheshire (GB)

Correspondence Address: Gauthier & Connors LLP;Suite 3300, 225 Franklin Street, Boston, MA, 02110, US

(21) Appl. No.: 11/063,378

(22) Filed: Feb. 22, 2005

(51) Int. Cl. A01C 23/00

(52) U.S. Cl. 111/118

(57) ABSTRACT

Ground injection, eg, aeration, apparatus adapted to be mounted on or drawn by a tractor and comprising one or more tines (12) reciprocated vertically by a crank (13) and crank shaft (13a) driven from a motor (14). Each tine (12) defines an internal passage (27) with outlet apertures (26). A compressor (24) connected to the passage (27) by a duct (23) having a poppet valve (21) actuated by a cam disc (19) on the crank shaft (13a) delivers a pulse of air to be injected into the ground through outlet apertures (26) at the position of maximum penetration of the ground by each tine (12). Instead of air, a liquid, a powder, or other gaseous substance may be injected into the ground where it is penetrated by each tine. The apparatus may include two or more rows of such tines and associated injection means.

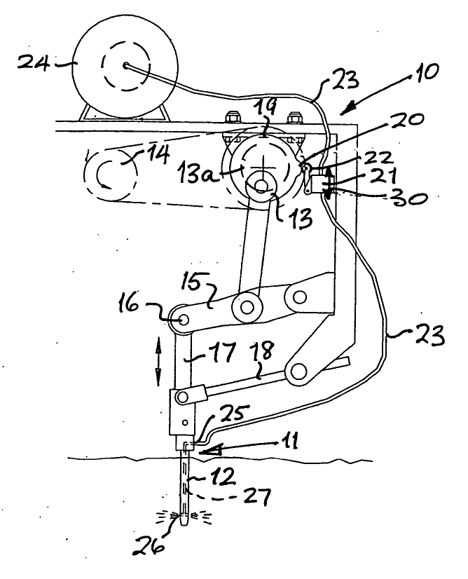

This invention concerns apparatus for injecting air or other substances into the ground and may consist of a machine which preferably, although not specifically, is adapted to be towed, for example, by a tractor and having a plurality of tines, preferably in a plurality of rows thereof and all connected to a drive mechanism for causing the tines repeatedly to penetrate the ground as the machine is drawn or propelled over the latter.

Aeration, for example, is carried out to relieve compaction of the ground, allow water penetration and in the case of a turfed area, to allow air to reach the grass roots to improve root depth.

Typically, aeration machines comprise a drive shaft, and each tine is connected via a crank to the drive shaft with a linkage which causes it to rise and fall to make penetrating engagement with the ground, usually to a depth of some 400 mm.

An object of the present invention is to enhance the action of penetration by injecting a substance into the ground where it is penetrated by the or each tine.

According to the present invention there is provided a ground injection apparatus comprising at least one tine, the or each tine being hollow defining an internal passage therein with one or more outlet apertures, the injection means communicating with the passage of the or each tine such that the substance injected into the passage is discharged through the or each outlet aperture, drive means for causing the tines cyclically to penetrate the ground in use, and means to inject a substance into the ground where it is penetrated by the tine; characterised in that the injection means comprises a supply of said substance, a duct to carry the substance from the supply to said internal passage, a flow control valve in said duct, an actuator for said flow control valve, a cam driven by said drive means and having at least one lobe adapted to engage and move said actuator at a predetermined point in the penetration cycle of said tine.

A pump to introduce the substance into the internal passage may be driven by the drive system for each tine and adapted to deliver a predetermined quantity of air into the internal passage thereof during penetration of the ground by the tine.

An embodiment of the invention will now be described, by way of example only, with reference to the accompany drawing which is a schematic view of a ground aeration apparatus constructed in accordance with the invention showing a tine inserted in the ground.

The drawing shows a ground aeration apparatus generally indicated at 10 adapted to be mounted on or drawn by a tractor (not shown) and comprising a row of tine assemblies 11 each having a tine 12, the latter being reciprocated in a vertical direction by crank 13 connected to a crankshaft 13a, belt driven from a shaft 14 of a motor.

The crank 13 causes oscillation of a pivoted arm 15 pivotally connected at 16 to an assembly 17 supporting the tine 12. A parallel link arm 18 maintains the movement of the tine in a generally vertical direction.

In accordance with the invention, the crankshaft 13a also carries a cam disc 19 having on its circumference a lobe 20.

A poppet valve 21 and actuator 22 are adjustably mounted on the apparatus as shown by arrows 30. The valve 21 is disposed in a flow line 23 connected to an air compressor 24 which may be driven from the shaft 14 or some other drive source.

The line 23 continues from the outlet of valve 21 to a port 25 in the base of the assembly 17.

As indicated at 27, the tine 12 has a central bore communicating with the port 25 and terminating in a pair of outlet apertures 26. Rotation of the crankshaft 13a and thus cam lobe 20 actuates valve 21 cyclically to release air into line 23 and bore 27.

In use, the mechanism is arranged such that for each penetrating movement of each tine 12 a pulse of air is injected via valve 21 from compressor 24 into the bore 27 so that the air is injected into the ground at the lowermost position occupied by the tine at maximum penetration. By setting the relative positions of cam disc 19 and valve 21, the pulse may be arranged such that the air is injected at the most desired position during the vertical passage of the tine through the soil whereby, for example, the air may be distributed throughout the depth of penetration of the tine including the upper and surface regions, or merely at or approaching the position of maximum penetration.

On the upward movement of the tine, when the cam lobe 20 leaves the actuator 22, the valve 21 is closed to prevent further flow of air until the tine descends into the ground once again. The period during which the or each valve 21 is open, as determined by the length of the lobe 20, is typically some 0.5 to 1 second, and the delivery of air occurs preferably at 10° before bottom dead centre of the crank 13.

On a machine comprising several rows of tines, each may be equipped with a compressor and valve whereby air is injected into the ground during each penetration. Alternatively, a single compressor may feed several tines or groups or rows of tines.

The tines in a group or row are preferably operated such that they penetrate the ground sequentially rather than simultaneously. This progressive penetration ensures smooth operation of the machine.

If required, valving may be provided to turn off the air supply for applications where air injection is not required or is disadvantageous.

It is not intended to limit the invention to the above examples alone, and includes any system which can deliver a substance into the ground where it is penetrated by the tine. This could include a separate hollow tine which penetrates the ground subsequent to penetration by a solid tine.

Whilst this description has referred to the injection of a pulse of air into the ground, other fluid materials including gases, liquids and powders may be introduced in the same manner. Thus for example, the ground may be dosed with a fertiliser or weed killer. If liquid is dispensed, the compressor 24 will be replaced by a liquid pump and reservoir.

The substance may be fed to the respective tines in timed sequence, from a common supply mounted on the apparatus or on a tractor.

Although preferably tractor drawn or propelled, the apparatus may be mounted on an independent carries which may be motor driven or manually propelled.

1. A ground injection apparatus comprising at least one tine, the or each tine being hollow defining an internal passage therein with one or more outlet apertures, the injection means communicating with the passage of the or each tine such that the substance injected into the passage is discharged through the or each outlet aperture, drive means for causing the tine cyclically to penetrate the ground in use, and means to inject a substance into the ground where it is penetrated by the tine; characterised in that the injection means comprises a supply of said substance, a duct to carry the substance from the supply to said internal passage, a flow control valve in said duct, an actuator for said flow control valve, a cam driven by said drive means and having at least one lobe adapted to engage and move said actuator at a predetermined point in the penetration cycle of said tine.

2. Ground engaging apparatus according to claim 1 comprising several tines connected to a common drive means and adapted for operation sequentially to penetrate the ground.

3. Ground injection apparatus according to claim 1, wherein the injection means comprises a pump to introduce air into the internal passage, the pump being driven by the drive system for the or each tine and adapted to deliver a predetermined quantity of air into the internal passage thereof sequentially according to an instantaneous position of the tine as determined by the drive means.

4. Ground injection apparatus according to claim 1, wherein the injection means is adapted to introduce the substance into the internal passage at a position of maximum penetration of the ground by the tine.

5. Ground injection apparatus according to claim 1 comprising at least one row of tines, each tine being adapted to be reciprocated in a vertical direction by a crank attached to a crank shaft and driven by a motor.

6. Ground injection apparatus according to claim 1 including a parallel link arm connected to each tine to maintain the movement of the tine in a generally vertical direction.

7. Ground injection apparatus according to claim 1, wherein the flow control valve is a poppet valve.

8. Ground injection apparatus according to claim 1, wherein said predetermined point is adjustable.

9. Ground injection apparatus according to claim 1, wherein the substance injected into the ground is a liquid.

10. Ground injection apparatus according to claim 1 wherein the substance injected into the ground is a powder.

11. Ground injection apparatus according to claim 1, wherein the internal passage within the or each tine extends generally throughout the length of the tine and communicates with at least one outlet aperture in the region of the lowermost extremity of the tine in use.

12. Ground injection apparatus according to claim 1, adapted such that the substance is fed to a plurality of tines in timed sequence from a common supply mounted on the apparatus.
